(19) United States
(12) Patent Application Publication
(10) Pub. No.: US 2014/0118928 A1
(43) Pub. Date: May 1, 2014

(54) ELECTRONIC DEVICE

(71) Applicants: INVENTEC (PUDONG) TECHNOLOGY CORPORATION, (US); INVENTEC CORPORATION, Taipei City (TW)

(72) Inventors: Yi-Lun Cheng, Taipei City (TW); Ming-Hung Lin, Taipei City (TW); Chun-Lung Lin, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 13/796,059

(22) Filed: Mar. 12, 2013

(30) Foreign Application Priority Data
Oct. 31, 2012 (CN) 201210429919.3

(51) Int. Cl. G06F 1/20

(52) U.S. Cl. CPC G06F 1/203
USPC 361/679.54; 165/170

(57) ABSTRACT

An electronic device comprises a case, a heat source and a radiator. The heat source is disposed inside the case. The radiator is disposed on the case and the radiator is kept away from the heat source at a distance. The radiator comprises a case body. A plurality of cellular compartments formed by a plurality of partition plates is disposed inside the case body. The cellular compartments are filled with a heat dissipation material. The radiator absorbs the heat of the heat source through thermal radiation.

### CROSS-REFERENCE TO RELATED APPLICATIONS

This non-provisional application claims priority under 35 U.S.C. §119(a) on Patent Application No(s). 201210429919.3 filed in China on Oct. 31, 2012, the entire contents of which are hereby incorporated by reference.

### BACKGROUND OF THE INVENTION

1. Field of the Invention

The present disclosure relates to an electronic device and more particularly to an electronic device having a radiator.

2. Description of the Related Art

As technology continuously advances, the articles of daily use for people nowadays are digitalized. Take mobile computing devices as examples, such as laptop and tablet computer, etc., have an advantage of convenience for carrying around. And the users can use the devices virtually anywhere.

Typically, a heat dissipation fin assembly and a fan are disposed inside a mobile computing device for eliminating the heat produced by the mobile computing device. Enhancements in the performance of mobile computing device are typically coupled with corresponding increases in the heat produced. To dissipate the additional heat, manufacturers have conventionally increased the fan power and the heat dissipation area of the heat dissipation fin assembly.

However, as technology advances, research and development technicians endeavor to develop mobile computing devices with higher performances and a compact, slim and light design. The above-mentioned convention of increasing the heat dissipation area of the heat dissipation fins and the power of the fan requires increasing the volume inside the mobile computing device for accommodating larger heat dissipation fins and a higher power fan. This hinders the objective of developing compact and slim mobile computing devices.

### SUMMARY OF THE INVENTION

An electronic device is provided by the present disclosure for achieving the requirement of heat dissipation for compact and slim mobile computing devices.

An electronic device disclosed by the present disclosure comprises a case, a heat source and a radiator. The heat source is located inside the case. The radiator is disposed inside the case and the radiator is kept away from the heat source at a distance. The radiator comprises a case body. A plurality of cellular compartments formed by a plurality of partition plates is disposed inside the case body. The cellular compartments are filled with a heat dissipation material. The radiator absorbs the heat of the heat source through thermal radiation.

According to the electronic device disclosed by the present disclosure, the strength of the radiator and even the overall strength of the electronic device are enhanced by the arrangement of the cellular compartments. Furthermore, the heat absorbing efficiency of the radiator is enhanced by using the heat dissipation material disposed inside the radiator for absorbing the heat. Additionally, because the radiator does not require an exhaust fan, the radiator can reduce the noise level and is suitable for slim electronic devices.

### BRIEF DESCRIPTION OF THE DRAWINGS

The present disclosure will become more fully understood from the detailed description given herein below for illustration only, and thus are not limitative of the present disclosure, and wherein:

FIG. 1 is a sectional view of a structure of an electronic device according to an embodiment of the disclosure;

FIG. 2A is a top structural view of a radiator in FIG. 1;

FIG. 2B is a perspective view of the radiator in FIG. 2A; and

FIG. 3 is a top structural view of the radiator according to another embodiment of disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

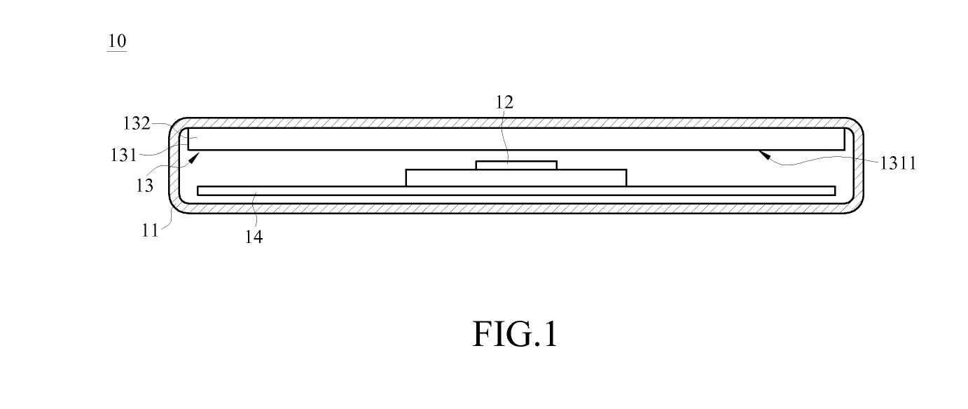

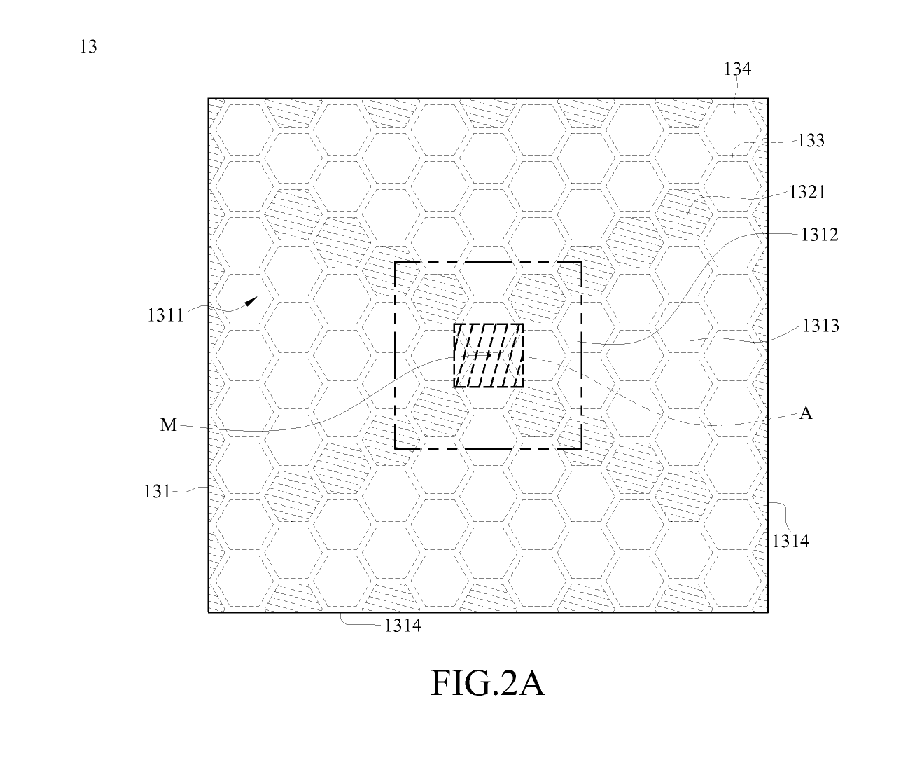

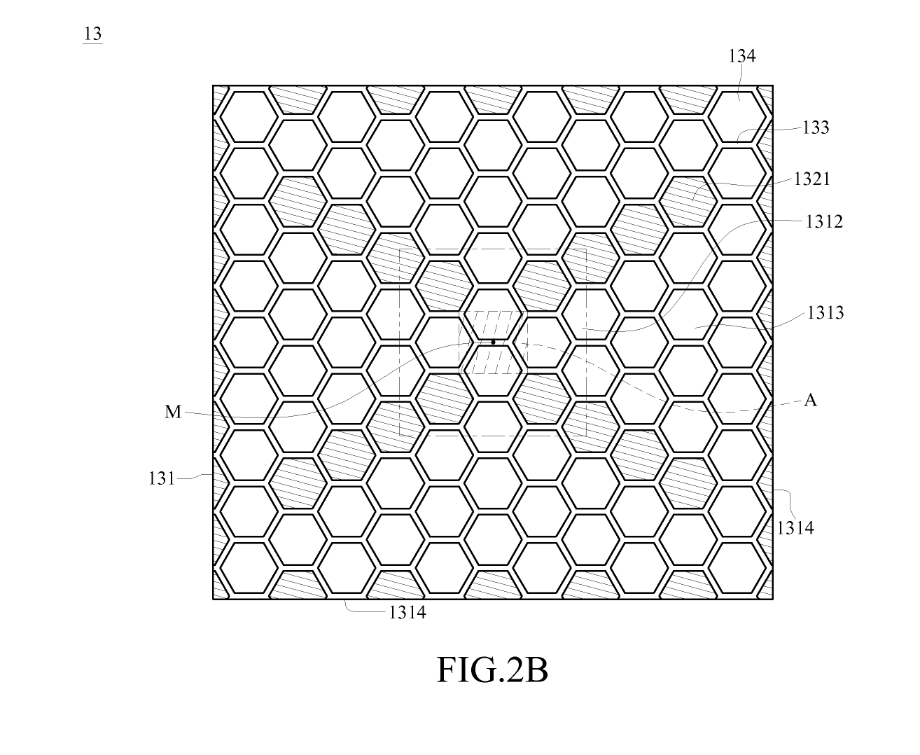

FIGS. 1, 2A and 2B illustrate one embodiment of an electronic device 10. FIG. 1 is a sectional view of a structure of the electronic device 10. FIGS. 2A and 2B are top and perspective views, respectively, of a radiator in FIG. 1.

An electronic device 10 in this embodiment comprises a case 11, a heat source 12 and a radiator 13. The electronic device 10 can be a tablet computer, a mobile phone or other electronic products.

A circuit board 14 is disposed inside the case 11. The heat source 12 is disposed on the circuit board 14 and inside the case 11. The heat source 12 can be a tablet computer, a mobile phone or a processing chip of another electronic product.

The radiator 13 is disposed inside the case 11 and the radiator 13 is kept away from the heat source 12 at a distance and not in contact with each other. The radiator 13 of the electronic device 10 of the present disclosure can absorb the heat produced by the heat source 12 effectively in order to allow, for examples, the heat sources of various electronic components to operate normally.

The radiator 13 comprises a case body 131. The case body 131 is a cuboid shape. The case body 131 is made of aluminum, copper or other suitable materials. A plurality of cellular hexagonal-shaped compartments 134 formed by a plurality of partition plates 133 is disposed inside the case body 131. The overall structural strength of the radiator 13 is enhanced by the cellular compartments 134. The case 11 is completely filled with the cellular compartments 134 in this embodiment. However, the feature of the case 11 being completely filled with the cellular compartments 134 does not limit the present disclosure. For example, in some other embodiments, the cellular compartments 134 are disposed in partial areas inside the case 11, and other areas not disposed with the cellular compartments 134 are filled with rectangular compartments formed by cross-shaped ribs instead of the cellular compartments 134.

The partition plates 133 are made of aluminum, copper or other suitable materials. The cellular compartments 134 are filled with a heat dissipation material 132. The heat dissipation material 132 inside each of the cellular compartments 134 can comprise copper material, a phase change material, an air, or a combination of copper material, phase change material and air. In general, the heat dissipation material 132 contains 15%-30% by volume of copper, 50%-85% by volume of a phase change material and 15%-20% by volume of air. More particularly, the heat dissipation material comprises 15%-20% by volume of copper, 64%-67% by volume of a phase change material and 16%-17% by volume of air. In this and some other embodiments, the phase change material is alkane, for example, olefin.

The phase change material in this embodiment can change from a solid state to a liquid state by absorbing the heat. During and until completion of the phase change, the temperature of the phase change material remains at a fixed value and does not increase while the phase change material absorbs the heat. The volume of the phase change material increases while changing from the solid state to the liquid state, and the air has an excellent compressibility for providing an expanding space for the phase change material. The air contained in the heat dissipation material 132 compresses to accommodate the increased volume of the phase change material after the phase change.

Furthermore, the case body 131 of the radiator 13 has a surface 1311 and the surface 1311 faces toward the heat source 12. A central area 1312 and an outer surrounding area 1313 are defined on the surface 1311. The outer surrounding area 1313 surrounds the central area 1312.

The central area 1312, the surface 1311 and the radiator 13 in this embodiment have an overlapped geometrical central point M. The area of the central area 1312 is preferably 10%-50% of the area of the surface 1311. In one particular embodiment, the area of the central area 1312 is 10% of the area of the surface 1311. The shape of the central area 1312 can be a scaled-down, proportionally reduced-size version of the area of the surface 1311. An orthographic projection range A of the heat source 12 on the surface 1311 is located on the central area 1312. The radiator 13 absorbs the heat of the heat source 12 by thermal radiation.

Referring to FIGS. 2A and 2B, some of the cellular compartments 134 are filled with a copper material 1321 (the cellular compartments 134 with slanted lines as shown in FIG. 2B), or are filled with the phase change material and air (the cellular compartments 134 with a blank space inside as shown in FIG. 2B). Some of the cellular compartments 134 filled with the copper material 1321 are contiguously arranged along lines or in patterns extending from the central area 1312 toward the outer surrounding area 1313. Other of the copper-filled cellular compartments 134 are disposed adjacent a side edge 1314 of the case body 131. The copper-filled cells facilitate the rapid transfer of heat from the central area 1312 to the outer surrounding area 1313 of the radiator 13, more evenly heating the whole radiator 13 and enhancing its heat absorbing effect.

It should be noted that, unless specifically so claimed, the filling locations of the copper material 1321 in this embodiment should not be construed as a limitation to the present disclosure. The present disclosure embraces other patterns of copper-filled cells.

Furthermore, in this embodiment, the cellular compartments 134 that overlap the orthographic projection range A of the heat source 12 are filled with the phase change material. This increases the heat absorbing efficiency of the radiator 13.

By arranging the copper material 1321 and the phase change material in suitable patterns and locations, the phase change material in the central area 1312 absorbs heat thermally radiated from the heat source 12 and undergoes a phase change. At the same time, the copper material 1321 speedily transfers heat from the phase change material to the outer surrounding area 1313. This facilitates even heating of the radiator 13, enhancing the heat absorbing efficiency of the radiator 13. The radiator 13 in this embodiment does not require an exhaust fan, making it suitable for slim electronic devices.

Because the heat dissipation material 132 inside the radiator 13 contains phase change material, the temperature of the phase change material does not increase as the phase change material absorbs heat during the phase change. Be selecting a suitable phase change material that changes phase at a comfortable temperature (e.g., between 15 and 45 degrees Celsius), for example, by employing a phase change material with a phase change temperature of approximately 37 degrees Celsius, the radiator 13 can be maintained at that comfortable temperature over a long period (e.g., for hours) while the radiator 13 absorbs heat. Thereby, when users hold the electronic device 10 over long hours, the problem of hands being burnt because of the continuous increased temperature of the case 11 of the electronic device 10 caused by the heat absorption of the radiator 13 can be prevented.

Furthermore, in this embodiment or other embodiments, a plurality of heat dissipation fins (not shown in the drawings) can be further disposed on the surface 1311 of the radiator 13 for enhancing the heat absorption efficiency of the radiator 13.

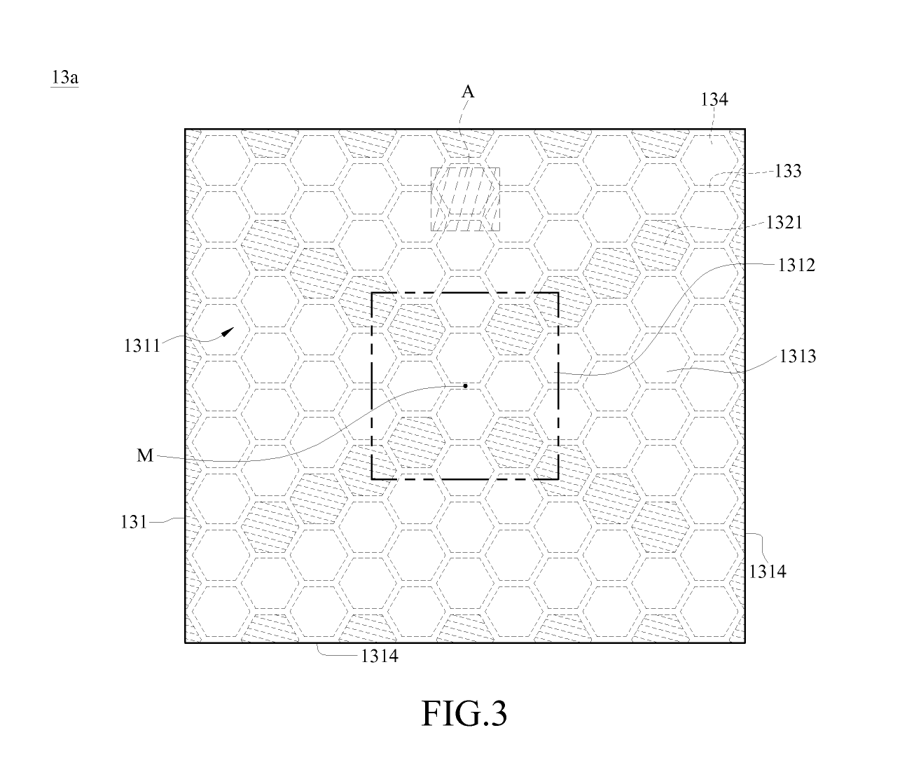

FIG. 3 is a top structural view of another embodiment of a radiator 13a.

This embodiment is similar to the embodiment in FIGS. 2A and 2B and therefore the same points will not be described herein again. The difference between this embodiment and the embodiment in FIGS. 2A and 2B is that the orthographic projection range A of the heat source 12 on the surface 1311 is located on the outer surrounding area 1313.

When the heat of the heat source 12 is transferred to the outer surrounding area 1313 of the radiator 13 by thermal radiation, the phase change material at a location of the outer surrounding area 1313 absorbs the heat and carries out phase change. At the same time, the copper material 1321 rapidly transfers heat from the phase change material to the central area 1312 and other locations of the outer surrounding area 1313. Again, the entirety of the radiator 13 is heated substantially evenly, enhancing the heat absorbing efficiency of the radiator 13.

According to the electronic device in the above embodiments, the strength of the radiator and even the overall strength of the electronic device are enhanced by the arrangement of the cellular compartments. Furthermore, because the heat dissipation material contains 15%-30% by volume of the copper material, 50%-85% by volume of the phase change material and 15%-20% by volume of air, heat is rapidly and substantially evenly spread throughout the radiator, enhancing the heat absorption efficiency of the radiator. Furthermore, because the heat dissipation material contains the phase change material, the radiator can be maintained at a comfortable temperature for holding over long hours during the heat absorption of the radiator. Additionally, because the radiator in the embodiments does not require an exhaust fan, the radiator is suitable for slim electronic devices and can reduce the noise level.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. An electronic device, comprising:
a case;
a heat source located inside the case; and
a radiator disposed inside the case and spaced apart from the heat source at a distance so as to absorb heat from the heat source through thermal radiation, the radiator comprising a case body and a plurality of cellular compartments formed by a plurality of partition plates disposed inside the case body, the cellular compartments being filled with a heat dissipation material.

2. The electronic device as claimed in claim 1, wherein the heat dissipation material contains 15%-30% by volume of copper, 50%-85% by volume of a phase change material and 15%-20% by volume of air.

3. The electronic device as claimed in claim 2, wherein the radiator has a surface facing the heat source, a central area and an outer surrounding area are defined on the radiator surface, the outer surrounding area surrounds the central area, a geometrical central point of the central area overlaps a geometrical central point of the radiator surface, an area of the central area is 10%-50% of an area of the radiator surface, and an orthographic projection range of the heat source on the radiator surface is located on the central area.

4. The electronic device as claimed in claim 3, wherein some of the cellular compartments are filled with the copper material and contiguously arranged to extend from the central area toward the outer surrounding area.

5. The electronic device as claimed in claim 2, wherein the radiator has a surface facing toward the heat source, a central area and an outer surrounding area are defined on the radiator surface, the outer surrounding area surrounds the central area, a geometrical central point of the central area overlaps a geometrical central point of the radiator surface, an area of the central area is 10%-50% of an area of the radiator surface, and an orthographic projection range of the heat source on the surface is located on the outer surrounding area.

6. The electronic device as claimed in claim 5, wherein some of the cellular compartments are filled with the copper material and contiguously arranged to extend from the central area toward the outer surrounding area.

7. The electronic device as claimed in claim 2, wherein the cellular compartments that overlap the orthographic projection range of the heat source are filled with the phase change material.

8. The electronic device as claimed in claim 2, wherein the cellular compartments adjacent a side edge of the case body are filled with the copper material.

9. The electronic device as claimed in claim 2, wherein the phase change material is an alkane.

10. The electronic device as claimed in claim 1, wherein the case body and the partition plates are made of aluminum.

11. A radiator for dissipating heat from an electronic device that has a heat source, the radiator comprising:
a case body;
a plurality of cellular compartments formed by a plurality of partition plates disposed inside the case body; and
heat dissipation material that fills the cellular compartments.

12. The radiator as claimed in claim 11, wherein the heat dissipation material contains 15%-30% by volume of copper, 50%-85% by volume of a phase change material and 15%-20% by volume of air.

13. The radiator as claimed in claim 12, wherein the radiator has a surface facing the heat source, a central area and an outer surrounding area are defined on the radiator surface, the outer surrounding area surrounds the central area, a geometrical central point of the central area overlaps a geometrical central point of the radiator surface, an area of the central area is 10%-50% of an area of the radiator surface, and an orthographic projection range of the heat source on the radiator surface is located on the central area.

14. The electronic device as claimed in claim 13, wherein some of the cellular compartments are filled with the copper material and contiguously arranged to extend from the central area toward the outer surrounding area.

15. The electronic device as claimed in claim 12, wherein the radiator has a surface facing toward the heat source, a central area and an outer surrounding area are defined on the radiator surface, the outer surrounding area surrounds the central area, a geometrical central point of the central area overlaps a geometrical central point of the radiator surface, an area of the central area is 10%-50% of an area of the radiator surface, and an orthographic projection range of the heat source on the surface is located on the outer surrounding area.

16. The electronic device as claimed in claim 15, wherein some of the cellular compartments are filled with the copper material and contiguously arranged to extend from the central area toward the outer surrounding area.

17. The electronic device as claimed in claim 12, wherein the cellular compartments that overlap the orthographic projection range of the heat source are filled with the phase change material.

18. The electronic device as claimed in claim 12, wherein the cellular compartments adjacent a side edge of the case body are filled with the copper material.

19. The electronic device as claimed in claim 12, wherein the phase change material is an alkane.

20. The electronic device as claimed in claim 1, wherein the case body and the partition plates are made of aluminum.
